(19) United States
(12) Patent Application Publication
(10) Pub. No.: US 2026/0320819 A1
(43) Pub. Date: Oct. 15, 2026

(54) SYSTEM AND METHOD FOR ENHANCING POSE ESTIMATION WITH ROLE-REVERSAL FINE-TUNING

(71) Applicant: Gentex Corporation, Zeeland, MI (US)

(72) Inventors: Ameen Ali, Tel Aviv-Yafo (IL); Bar Mayo, Rehovot (IL)

(21) Appl. No.: 19/117,181

(22) PCT Filed: Nov. 15, 2024
(86) PCT No.: PCT/IB2024/061414

§ 371 Date: Mar. 31, 2025

Related U.S. Application Data
(60) Provisional application No. 63/599,829, filed on Nov. 16, 2023.

(51) Int. Cl. G06T 7/73; G06F 16/583; G06V 20/59

(52) U.S. Cl. CPC G06T 7/73; G06F 16/583; G06V 20/59

(57) ABSTRACT

A system and method are provided for pose estimation comprising the steps: (a) receive a query image and a support image with original ground truth notations; (b) perform initial pose estimation using a class-agnostic pose estimation model to predict key-points to estimate initial pose within the query image using the support image and the original ground truth notations; (c) using the query image with the predicted key-points designated as ground truth notations, predict key-points to estimate a pose within the support image; (d) updating model parameters of the pose estimation model to optimize pose estimation using the original ground truth pose of the support image and the predicted pose of the support image obtained from step (c); and (e) generating a fine-tuned pose estimation for the query image using: (i) the updated model parameters obtained from step (d) and (ii) the support image and its original ground truth notations.

### CROSS-REFERENCE TO RELATED APPLICATION

This application claims priority to and the benefit under 35 U.S.C. § 119(e) of U.S. Provisional Patent Application No. 63/599,829, filed on Nov. 16, 2023, entitled “SYSTEM AND METHOD FOR ENHANCING POSE ESTIMATION WITH ROLE-REVERSAL FINE-TUNING,” by Ameen Ali et al., the entire disclosure of which is incorporated herein by reference.

### BACKGROUND OF THE DISCLOSURE

The present disclosure generally relates to a system and method for pose estimation, and more specifically to a system and method for pose estimation of a vehicle occupant.

### SUMMARY OF THE DISCLOSURE

According to one aspect of the present disclosure, a method is provided for pose estimation performed by a processor, the processor configured to perform the following steps: (a) receive a query image and a support image with original ground truth notations including key-points; (b) perform initial pose estimation using a class-agnostic pose estimation model to predict key-points to estimate an initial pose within the query image using the support image and the original ground truth notations; (c) using the query image with the predicted key-points designated as ground truth notations, predict key-points to estimate a pose within the support image; (d) updating model parameters of the class-agnostic pose estimation model to optimize objective of pose estimation using the original ground truth pose of the support image along with the predicted pose of the support image obtained from step (c); and (e) generating a fine-tuned pose estimation for the query image using: (i) the updated model parameters obtained from step (d) and (ii) the support image and its original ground truth notations.

According to another aspect of the present disclosure, a system is provided for estimating pose, comprising: a processor configured to perform the following steps: (a) receive a query image and a support image with original ground truth notations including key-points; (b) perform initial pose estimation using a class-agnostic pose estimation model to predict key-points to estimate an initial pose within the query image using the support image and the original ground truth notations; (c) using the query image with the predicted key-points designated as ground truth notations, predict key-points to estimate a pose within the support image; (d) updating model parameters of the class-agnostic pose estimation model to optimize objective of pose estimation using the original ground truth pose of the support image along with the predicted pose of the support image obtained from step (c); and (e) generating a fine-tuned pose estimation for the query image using: (i) the updated model parameters obtained from step (d) and (ii) the support image and its original ground truth notations.

According to another aspect of the present disclosure, a method is provided for pose estimation performed by a processor, the processor configured to perform the following steps: (a) receive a query image and a plurality of support images with original ground truth notations including key-points; (b) perform initial pose estimation using a class-agnostic pose estimation model to predict key-points to estimate an initial pose within the query image using the support images and the original ground truth notations; (c) using the query image with the predicted key-points designated as ground truth notations, predict key-points to estimate poses within the support images; (d) updating model parameters of the class-agnostic pose estimation model to optimize objective of pose estimation using the original ground truth poses of the support images along with the predicted poses of the support images obtained from step (c); and (e) generating a fine-tuned pose estimation for the query image using: (i) the updated model parameters obtained from step (d) and (ii) the support images and their original ground truth notations.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an electrical circuit diagram in block form of a system for pose estimation;

FIG. 2 is a flowchart of the enhanced pose estimation method executed using the system shown in FIG. 1;

FIG. 3A shows an example of a source image including key-points;

FIG. 3B is an example of a query image;

FIG. 3C is an example of a query image with key-points resulting from application of the method depicted in FIG. 2;

FIG. 3D shows a sequence of steps of the method 50 with representations of the query and source images;

FIG. 4 is Table 1 showing comparisons of the results of the inventive method to prior art methods using a 1-shot setting;

FIG. 5 is Table 2 showing comparisons of the results of the inventive method to prior art methods using a 5-shot setting;

FIG. 6 is Table 3 showing cross super-category comparisons of the results of the inventive method to prior art methods using a 1-shot setting; and

FIG. 7 is an electrical circuit diagram in block form of a driver monitoring system using the enhanced category-agnostic pose estimation algorithm generated by the system in FIG. 1 and the method of FIG. 2.

The components in the figures are not necessarily to scale, emphasis instead being placed upon illustrating the principles described herein.

### DETAILED DESCRIPTION

The present illustrated embodiments reside primarily in combinations of method steps and apparatus components related to pose estimation. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

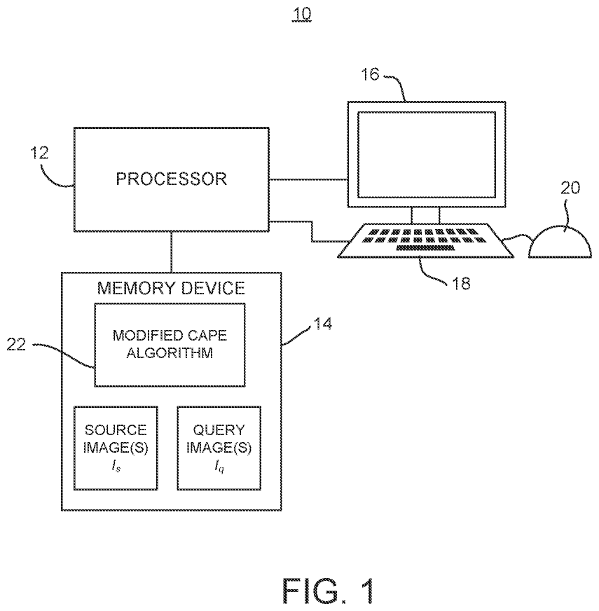

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Driver monitoring systems (DMSs) are known to use an image sensor to capture multiple images comprising a sequence of two dimensional (2D) images and three dimensional (3D) images of the vehicle cabin. A pose detection algorithm is applied on each of the obtained sequences of 2D images to yield a skeleton representation of the driver and/or other vehicle occupants. The 3D images of the sequence of 3D images are analyzed to extract one or more depth values of the driver and/or other occupants. The 3D images are combined with the skeleton representations to yield a skeleton model for the driver and/or each one of the other occupants. The skeleton model includes information relating to the distance of one or more key-points of the skeleton model from a viewpoint. The skeleton model may be used for a variety of different functions such as estimating the mass of the occupants (useful for airbag deployments), determining driver attentiveness/intoxication, driver health (whether they are breathing), and detection of children. An example of such a DMS is disclosed in commonly-assigned U.S. Patent Application Publication No. US 2022/0292705 A1, the entire disclosure of which is incorporated herein by reference.

The embodiments described below relate to a training system and method for enhanced pose estimation as used by the pose detection algorithm embodied within a DMS. By more accurately estimating the pose of a vehicle occupant, the pose detection algorithm and its DMS become more reliable.

A typical training system includes a computer having at least a processor and a memory device. The computer has access to a plurality of source images with ground truth pose annotations (the key-points of a skeleton model) to enhance the prediction of pose in query images. The computer may also have access to a training set and a query set of images.

The training set may still differ from both the support and query sets. Additionally, the camera employed in the vehicle for Driver Monitoring System (DMS) purposes might be of a different type than the camera used in the training system, potentially leading to variations in sensor configurations, lighting source locations, and field of view. These inherent differences emphasize the significance of role-reversal fine-tuning to effectively adapt the pose estimation model parameters to the unique characteristics of the support and query images during deployment.

Given a query image and a small set of fully-labeled relevant support sample images, class-agnostic pose estimation (CAPE) models recover a set of desired key-points in the query image. The model is pre-trained for this few-shot task on a relatively large set of annotated images.

A successful CAPE method manifests two desired properties of biological vision systems: (1) the ability to transfer knowledge gained through a similar but different scenario, and (2) the ability to use the first capability to accurately annotate a new image given a handful of relevant samples.

This fine-tuning occurs by reversing the role of the query image and the support set. It is somewhat reminiscent of the Natural Language Processing (NLP) technique called back translation (BT), but different in key aspects. In BT, one creates virtual translation samples by considering a text a in language A, translating it automatically to text b in language B, and using the pair of samples (b, a) as a training sample from language B to language A.

In role reversal, the query image becomes a support image, using pseudo-labels that the pre-trained CAPE model provides. In this phase, the handful of support images given as relevant samples in the CAPE task are used as query images. The role-reversal-based fine-tuning boosts the performance of the CAPE model by a sizable margin.

Referring to FIG. 1, reference numeral 10 generally designates a system for pose estimation. The system 10 may include a processor 12, a memory device 14 coupled to the processor 12, a display 16, a keyboard 18, and a mouse 20. The processor 12 may be configured to execute an algorithm 22 implementing the CAPE model as modified using the method described below.

Pose estimation serves as a foundational task in computer vision, aimed at precisely locating semantic key-points in a diverse array of instances. Historically, pose estimation techniques have been tailored to specific categories, spanning humans, animals, and vehicles.

In this pursuit, two main representation approaches have been proposed, a regression-based method and a heatmap-based method. Regression-based methods provide direct predictions of joint coordinates, showcasing efficiency but sometimes suffering from diminished accuracy due to complex non-linear mappings. In contrast, heatmap-based methodologies that represent key-point locations as probability distribution have risen to prominence due to their strong localization and generalization capabilities. As explained below, the present embodiments use heatmap-based methodologies. Category-agnostic vision models are designed to provide versatility across a wide array of categories in various tasks using limited samples. These few-shot learning tasks encompass object detection, segmentation, object counting, viewpoint estimation and pose estimation.

Category-agnostic models fall into two primary categories: meta-learning and metric learning approaches. Meta-learning fine tunes the model with optimized parameters, which enables it to adapt to new tasks based on limited support samples. Metric learning-based approaches involve matching query images with support images and their corresponding labels within an embedding space, leveraging informative cues from the support samples to guide the target task.

The technique of back-translation, predominantly employed in NLP, showcases its effectiveness in leveraging both monolingual and bilingual data to enhance language pairs facing low-resource constraints.

A step in the successful implementation of this method involves filtering out suboptimal backtranslation pairs. Notably, a similarity measure has been utilized between the source sentence and its translated counterpart, assuming a shared underlying meaning. However, when dealing with CAPE, there is an absence of a straight-forward parallel similarity measure between source, support, and output images poses.

Moreover, filters have been utilized based on linguistic priors such as lexical similarity, sentence length, punctuation, and related factors. In our specific context, these priors prove irrelevant due to the absence of a clear predefined structure.

Local learning approaches focus on making predictions by using models that concentrate on training samples near each test sample, ensuring predictions are based on what is deemed the most relevant data.

A one-shot similarity kernel compares a single test sample with many training samples but lacks the fine-tuning of a model based on a single sample. Recently, it has been proposed to apply local learning for single-sample domain adaptation. Tailoring, which is a method employing meta-learning for local learning, involves applying unsupervised learning on a dataset created by augmenting the test sample.

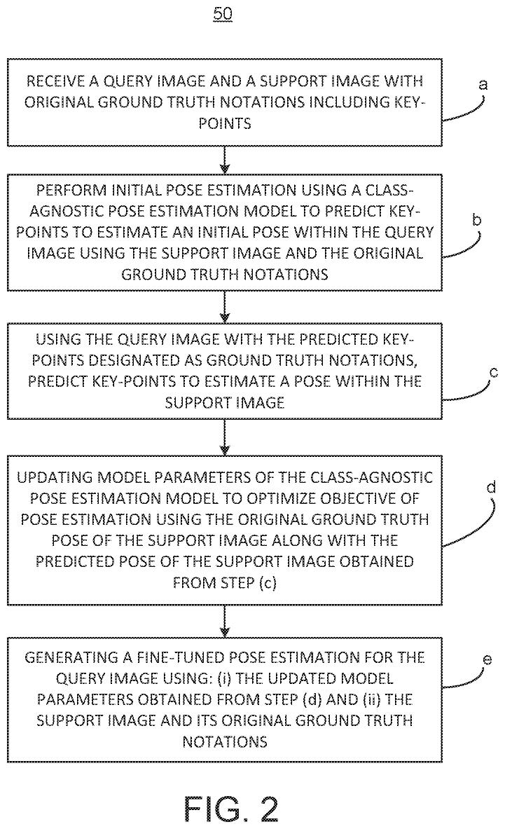

The inventive method of pose estimation is first generally described with respect to the flow chart shown in FIG. 2 and then described in detail thereafter.

The method 50 is provided for pose estimation performed by the processor 12, which is configured to perform the following steps: (a) receive a query image and a support image with original ground truth notations including key-points; (b) perform initial pose estimation using a class-agnostic pose estimation model to predict key-points to estimate an initial pose within the query image using the support image and the original ground truth notations; (c) using the query image with the predicted key-points designated as ground truth notations, predict key-points to estimate a pose within the support image; (d) updating model parameters of the class-agnostic pose estimation model to optimize objective of pose estimation using the original ground truth pose of the support image along with the predicted pose of the support image obtained from step (c); and (e) generating a fine-tuned pose estimation for the query image using: (i) the updated model parameters obtained from step (d) and (ii) the support image and its original ground truth notations. This method can be performed using a plurality of support images with their ground truth notations.

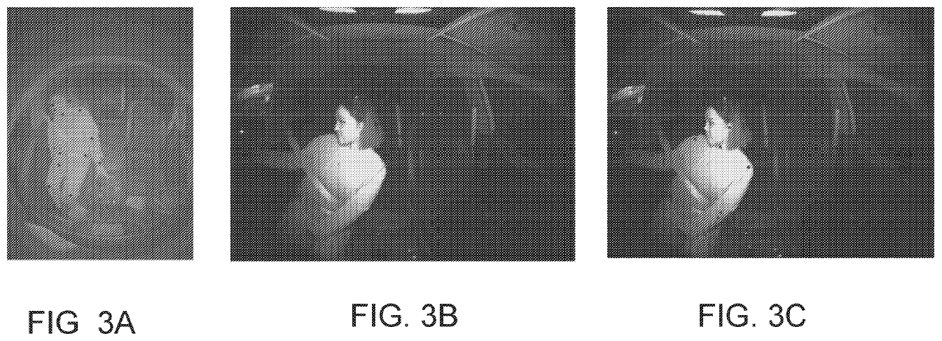

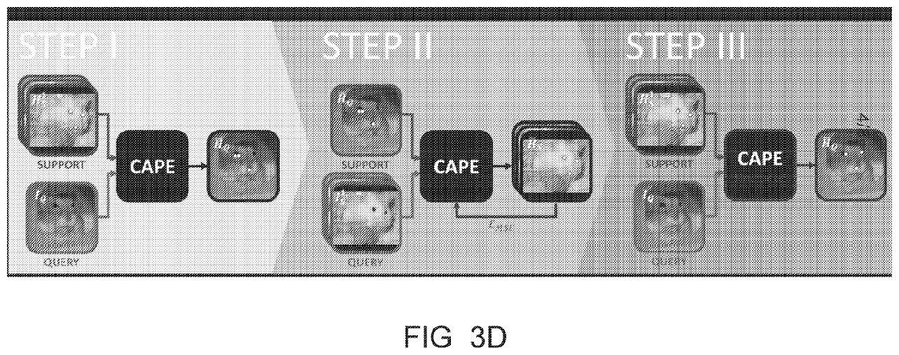

FIG. 3A shows an example of a source image including key-points. FIG. 3B is an example of a query image. FIG. 3C is an example of a query image with key-points resulting from application of the method 50. FIG. 3D shows a sequence of steps of the method 50 with representations of the query and source images. Step I of FIG. 3D corresponds to steps (a) and (b) of method 50. Step II corresponds to steps (c) and (d) of method 50. Step Ill corresponds to step (e) of method 50.

Having generally described the method 50, the foundational aspects and initial configurations for the task of class-agnostic pose estimation are presented followed by details of the method.

The core objective of CAPE is to predict instance-specific key-points within a query image based on the information provided by one or a few support images, each accompanied with ground truth key-point annotations.

Elements of CAPE include: (1) the heatmap representation, (2) the support set, (3) the query image, and (4) training objectives.

Heatmaps are a common representation in pose estimation. They quantify the likelihood of key-points across an image. Heatmaps may be used in steps (b), (c), and (e) of the above-described method 50. Heatmaps are computed using Gaussian kernels, and the equation for a single-key-point heatmap is as follows:

$${H}^{k} ( x , y ) = exp ( − \frac{{( x − {x}_{k} )}^{2} + {( y − {y}_{k} )}^{2}}{2 {σ}^{2}} ) ∈ {ℛ}^{H \times W}$$

where H^{k}(x, y) is the heatmap value for key-point k at position (x, y), (xₖ, yₖ) are ground-truth key-point coordinates, σ controls the kernel's spread, and H, W are the heatmap width and height dimensions, respectively.

The support set, denoted as S, comprises information from one or more support images. Specifically, S={(Iₛ, Hₛ)₁, (Iₛ, Hₛ)₂, . . . , (Iₛ, Hₛ)ₙ}, where Iₛ represents a support image and {Hₛ^{k}}ₖ^{k}=1 represents a list of key-point heatmaps, such that Hₛ^{k} represents the heatmap representation of the k'th joint key-point of the support image Iₛ and K is the maximum number of joints.

The heatmap representation of all the joints of the support image Iₛ can be obtained by:

$${H}_{s} = {\sum }_{k = 1}^{K} {H}_{s}^{k} ∈ {ℛ}^{H \times W}$$

In order to obtain the (x, y) coordinates of the pose from the heatmap of key-points H, the process involves identifying the positions of the heatmap peaks:

(x₁,y₁),(x₂,y₂), . . . ,(x_{K},y_{K})=argmax(H)

Two scenarios may be tested: In the 1-shot setting, a single support image is provided, and in the 5-shot setting, five support images are available.

The query image, denoted as I_{q}, is the image for which we aim to predict the instance-specific key-points. It represents the target image in the pose estimation task, and the goal is to predict the spatial coordinates of key-points on this image, given the support set S.

The goal is to predict the key-points for the query image I_{q} represented as a key-point heatmap \tilde{H}_{q}, given the few-shot support set S={(Iₛ, Hₛ)₁, (Iₛ, Hₛ)₂, . . . , (Iₛ, Hₛ)ₙ}. Formally, for the 1-shot settings, where we have S={(Iₛ, Hₛ)}, this can be expressed as:

$${\{ \tilde{{H}_{q}^{k}} \}}_{k = 1}^{K} = f ( {I}_{q} , S )$$

$${\tilde{H}}_{q} = {\sum }_{k = 1}^{K} \tilde{{H}_{q}^{k}} ∈ {ℛ}^{H \times W} ,$$

where f is the CAPE model, K is the number of key-points (we assume all samples in S along with the query image I_{q} have the same number of key-points).

The model f is learned by optimizing a Mean Square Error (MSE) loss function, minimizing the dissimilarity between the predicted query key-point heatmap \tilde{H}_{q} and the ground truth query key-point heatmap H_{q}:

$${ℒ}_{H} ( {\tilde{H}}_{q} , {H}_{q} ) = \frac{1}{H \times W} {\sum }_{i = 1}^{W} {\sum }_{j = 1}^{H} ( {\tilde{H}}_{q} ( i , j ) − {H}_{q} ( i , j ) )$$

Parentheses are used, as above, to index elements within the heatmap.

In the following, the novel contribution termed Test-time Role-Reversal (T2R2) is introduced, which is a sequential process that operates during the test phase. One advantage of the inventive approach is its model-agnostic nature, allowing for an effortless integration with any pre-trained model for the task of class-agnostic pose estimation, characterized by the utilization of the query and support notations. For brevity, notations for the 1-shot scenario are presented, while noting that the 5-shot variant can be applied in a similar manner.

Initially, using the support image(s) and the associated ground truth key-point heatmaps S={(Iₛ, Hₛ)}, the key-point heatmaps \tilde{H}_{q} are predicted for the query image I_{q}.

Subsequently, the roles of the support and the query images are reversed, treating the query image I_{q} with its predicted heatmaps \tilde{H}_{q} as the “new support image” and every original support image Iₛ with its associated ground-truth heatmaps (Hₛ) as the “new query image.” This reversal allows model-predicted key-point heatmaps \tilde{H}ₛ to be obtained for Iₛ, which can be compared to the ground truth key-point heatmaps \tilde{H}ₛ.

Formally, we define a reverse-role support set \tilde{S}={(I_{q}, H_{q})} and an additional forward pass is performed as follows for every (Iₛ, Hₛ)∈S:

$${\{ \tilde{{H}_{s}^{k}} \}}_{k = 1}^{K} = f ( {I}_{s} , \tilde{S} )$$

$${\tilde{H}}_{s} = {\sum }_{k = 1}^{K} \tilde{{H}_{s}^{k}} ∈ {ℛ}^{H \times W} .$$

The test-time fine-tuning step for the test sample (I_{q}, S) can now be applied by optimizing the following loss:

$${\sum }_{( {I}_{s} , {H}_{s} ) ∈ S} {ℒ}_{H} ( {\tilde{H}}_{s} , {H}_{s} )$$

An optional algorithm for refining the initial query-pose predictions \tilde{H}_{q} may be used to obtain query-pose predictions Ĥ_{q}. The algorithm consists of several steps: firstly, for each testing sample represented as a tuple (I_{q}, (Iₛ, Hₛ)), where I_{q} represents the query image, Iₛ represents the support image, and Hₛ∈R^{H×W} corresponds to the ground-truth key-point heatmap for the support image, the ground-truth support image key-point heatmap Hₛ is stored in a pose pool denoted as P.

The k-Nearest Neighbor (kNN) algorithm is then utilized to retrieve the k-nearest neighbors' support images' ground truth heatmaps sharing the same view as the query predicted heatmap \tilde{H}_{q} from the pose pool P:

$$( {i}_{1} , {i}_{2} , … , {i}_{k} ) = k NN ( \tilde{{H}_{q}} , 𝒫 , k ) ,$$

where k is the total number of neighbors for the kNN algorithm and i₁, i₂, . . . , iₖ are the indices of the nearest neighbors of \tilde{H}_{q} in P. In the final stage of the refinement process, the predicted heatmap of the query image \tilde{H}_{q} is enhanced by averaging it with the k nearest neighbor heatmaps as follows:

$$\hat{P} = \{ {\tilde{H}}_{q} , 𝒫 ( {i}_{1} ) , 𝒫 ( {i}_{2} ) , … 𝒫 ( {i}_{k} ) \}$$

$${\hat{H}}_{q} = \frac{1}{k + 1} {\sum }_{i = 1}^{k + 1} \hat{P} ( i )$$

Finally, the refined model predicted-key-point heatmap Ĥ_{q} is used instead of \tilde{H}_{q} for defining the new support set Ŝ={(I_{q}, Ĥ_{q})}, and the role-reversal step is performed as follows:

$${\{ \hat{{H}_{s}^{k}} \}}_{k = 1}^{K} = f ( {I}_{s} , \hat{S} )$$

$${\hat{H}}_{s} = {\sum }_{k = 1}^{K} \hat{{H}_{s}^{k}} ∈ {ℛ}^{H \times W} .$$

The test-time fine-tuning step for the test sample (I_{q}, S) thus can now be applied by optimizing the following modified Loss:

$${ℒ}_{H} ( {\hat{H}}_{s} , {H}_{s} )$$

### Experimental Data

In this section, we present a series of experiments aimed at assessing the efficacy of the role-reversal fine-tuning approach in enhancing class-agnostic pose estimation performance. We adopt 1-shot settings, where a single support image accompanies the query image during both the training and testing phases. Additionally, we also adopt 5-shot setting, involving five distinct support images for the query image. Lastly, we also test the cross-super category experiment. To comprehensively evaluate our model, we train it on all but one super-category within the MP-100 dataset and subsequently evaluate its performance on the excluded super-category, this experiment is designed to assess the generalization capability of the CAPE models.

In order to assess the performance of our approach, we have adopted the MP100 dataset described in Lumin Xu, Sheng Jin, Wang Zeng, Wentao Liu, Chen Qian, Wanli Ouyang, Ping Luo, and Xiaogang Wang, Pose for everything: Towards category-agnostic pose estimation. In European Conference on Computer Vision, pages 398-416. Springer, 2022. The MP100 dataset comprises more than 18,000 images drawn from 100 distinct categories, the number of key-points varies with the different categories ranging from 8 to 68. Five different splits are used, on each split the training, validation, and test categories have no overlaps, i.e., the categories for evaluation/testing are not accessed during training. The Probability of Correct Key-point (PCK) was used as an evaluation metric, which is a widely adopted metric in pose estimation evaluation. This metric determines correctness based on whether the normalized distance between the predicted key-point and the ground truth key-point falls below a designated threshold (σ). The formula for PCK is as follows:

$$PCK @ σ = \frac{1}{N} {\sum }_{i = 1}^{N} \text{?} ( \frac{{‖ {p}_{i} - {p}_{i}^{*} ‖}_{2}}{d} \leq σ ) ,$$

where pᵢ and pᵢ* are the coordinate locations of the predicted and the ground-truth key-point, d is a normalization term which is equal to the longest side of the ground-truth bounding box and N is the total number of key-points. The PCK@0.2 was adopted as the evaluation metric where σ=0.2.

In implementing our method, which is exclusively applied at test time and remains model-agnostic, we load the pre-trained weights for the Capeformer model. For optimization, we employ the Adam optimizer with a learning rate set to 1×10⁻⁶ and a weight decay of 5×10⁻⁵. For the Nearest-Neighbor refinement process we set k=3 as the number of neighbors for the kNN algorithm. No data augmentations are applied during the fine-tuning process, and the loss is optimized per-sample. This strategy ensures the integration of the role-reversal approach seamlessly into any class-agnostic pose estimation framework.

In order to quantitatively evaluate the efficacy of our proposed role-reversal fine-tuning, we conduct a comprehensive comparison with established benchmarks in class-agnostic pose estimation. Specifically, we compare our approach with POMnet [Lumin Xu, Sheng Jin, Wang Zeng, Wentao Liu, Chen Qian, Wanli Ouyang, Ping Luo, and Xiaogang Wang, Pose for everything: Towards category-agnostic pose estimation. In European Conference on Computer Vision, pages 398-416. Springer, 2022], which employs a shared transformer backbone for processing both query and support, followed by a regression head to infer similarity between support and query images. Additionally, our method is compared with Capeformer [Min Shi, Zihao Huang, Xianzheng Ma, Xiaowei Hu, and Zhiguo Cao, Matching is not enough: A two stage framework for category-agnostic pose estimation, In Proceedings of the IEEE/CVF Conference on Computer Vision and Pattern Recognition, pages 7308-7317, 2023], an extension of POMnet featuring a two-stage framework. In the first stage, matched key-points are treated as similarity-aware position proposals, while the second stage focuses on refining these initial proposals by learning to fetch relevant features. Lastly, we also include three additional baselines ProtoNet, MAML and Fine-tune. This comparative analysis serves to assess the effectiveness of our role-reversal fine-tuning approach within the context of class-agnostic pose estimation.

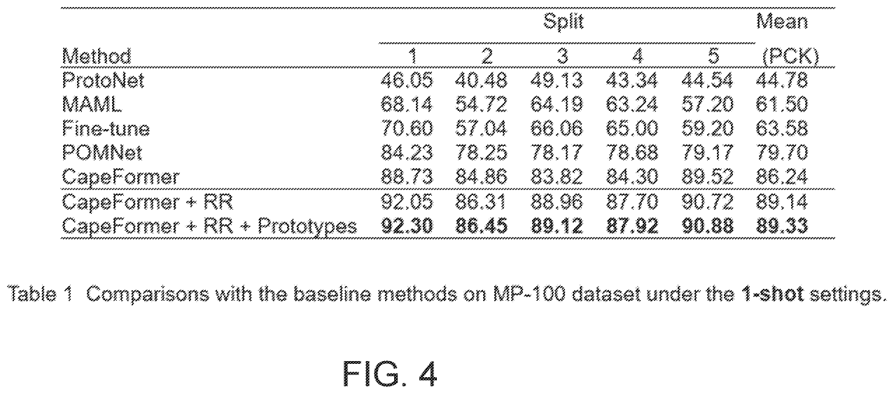

The results for the 1-shot setting are shown in Table 1 appearing in FIG. 4, as can be seen, the proposed role-reversal finetuning (RR) consistently improves the performance of the baseline model adopted Capeformer across the 5 different splits. To mitigate category bias, the average improvement across these 5 different splits is also reported, obtaining a 2.9% improvement compared to Capeformer. Moreover, with the adoption of the Nearest-Neighbor Pseudo-Label refinement process (Prototypes), the performance is further improved with a gap of 3.09%.

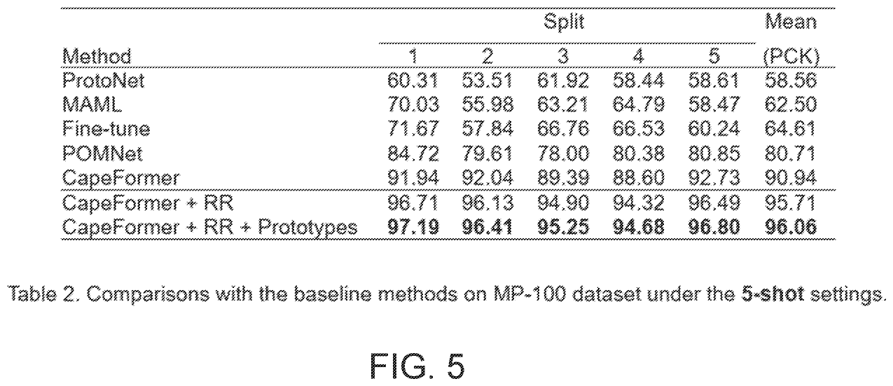

Results for the 5-shot setting are illustrated in Table 2 shown in FIG. 5. Notably, the inventive method exhibits a substantial improvement over previous benchmarks, showcasing a noteworthy gap of 5.12 compared to Capeformer. This underscores the efficacy of the inventive role-reversal strategy, particularly in utilizing additional information when multiple support samples are available.

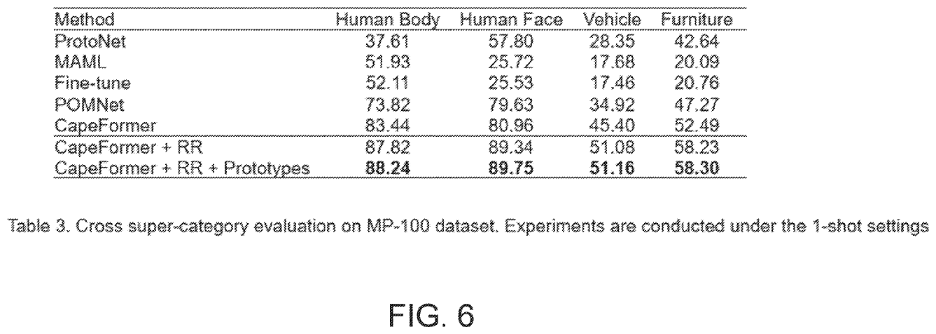

Lastly, in the cross super-category experiment, we systematically assess the generalization capability of the proposed role-reversal fine-tuning. For this evaluation, the model is trained on all super-categories from the MP-100 dataset except one, and its performance is evaluated on the excluded super-category. The considered super-categories include human body, human face, vehicle, and furniture. As depicted in Table 3 shown in FIG. 6, the inventive role-reversal fine-tuning consistently outperforms all previously proposed methods, showcasing an average gap of 6.04 compared to the most recent model Capeformer. Notably, the Prototypes refinement process contributes to an additional improvement of 0.24. However, it is worth mentioning that the improvement in the vehicle and furniture categories is more limited, possibly due to the distinct nature of these categories compared to the training categories, in contrast to human face or body.

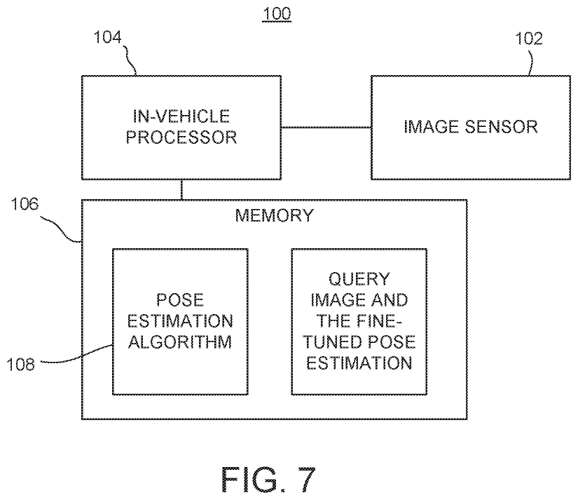

As shown in FIG. 7, a driver monitoring system 100 for a vehicle may include an image sensor 102 installed in the vehicle to capture images of a cabin of the vehicle including a region where the driver is located. The driver monitor system 100 may also include an in-vehicle processor 104 coupled to the image sensor 102 and a memory 106. The in-vehicle processor 104 is configured to execute the pose estimation algorithm 108 stored in memory 106 on images captured by the image sensor 102 using the query image and the fine-tuned pose estimation generated by the above method 50 in order to estimate a pose of the driver and/or other vehicle occupants. Further details of such a driver monitoring system 100 are disclosed in commonly-assigned U.S. Patent Application Publication No. US 2022/0292705 A1, the entire disclosure of which is incorporated herein by reference.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

1. A method of pose estimation performed by a processor, the processor configured to perform the following steps:
(a) receive a query image and a support image with original ground truth notations including key-points;
(b) perform initial pose estimation using a class-agnostic pose estimation model to predict key-points to estimate an initial pose within the query image using the support image and the original ground truth notations;
(c) using the query image with the predicted key-points designated as ground truth notations, predict key-points to estimate a pose within the support image;
(d) updating model parameters of the class-agnostic pose estimation model to optimize objective of pose estimation using the original ground truth pose of the support image along with the predicted pose of the support image obtained from step (c); and
(e) generating a fine-tuned pose estimation for the query image using: (i) the updated model parameters obtained from step (d) and (ii) the support image and its original ground truth notations.

2. The method of claim 1, wherein the step of updating model parameters includes repeating steps (c)-(d) until errors between the original pose of the support image and the predicted pose of the support image are minimized.

3. The method of claim 1, wherein step (b) includes using a heatmap representation.

4. The method of claim 3, wherein the heatmap representation H^{k} is computed using Gaussian kernels, and the equations for the heatmap is as follows:
$${H}^{k} ( x , y ) = exp ( - \frac{{( x - {x}_{k} )}^{2} + {( y - {y}_{k} )}^{2}}{2 {σ}^{2}} ) ∈ {ℛ}^{H \times W}$$
where H^{k}(x, y) is the heatmap value for key-point k at position (x, y), (xₖ, yₖ) are ground-truth key-point coordinates, σ controls the kernel's spread, and H, W are the heatmap width and height dimensions, respectively.

5. The method of claim 4, wherein a set of support images denoted as S comprises information from one or more support images, wherein S={(Iₛ, Hₛ)₁, (Iₛ, Hₛ)₂, . . . , (Iₛ, Hₛ)ₙ}, where Iₛ represents a support image and {Hₛ^{k}}ₖ^{K}=1 represents a list of key-point heatmaps, such that Hₛ^{k} represents the heatmap representation of the k'th joint key-point of the support image Iₛ and K is the maximum number of joints,
wherein the heatmap representation of all the joints of the support image Iₛ can be obtained by:
$${H}_{s} = {\sum }_{k = 1}^{K} {H}_{s}^{k} ∈ {ℛ}^{H \times W} .$$

6. The method of claim 5, wherein the set of support images S includes only one support image Iₛ such that S={(Iₛ, Hₛ)}, and wherein a key-point heatmap \tilde{H}_{q} for the query image I_{q}, is expressed as:
$${\{ {\tilde{H}}_{q}^{k} \}}_{k = 1}^{K} = f ( {I}_{q} , S )$$
$${\tilde{H}}_{q} = {\sum }_{k = 1}^{K} {\tilde{H}}_{q}^{k} ∈ {ℛ}^{H \times W} ,$$
where f is the class-agnostic pose estimation model, and K is the number of key-points.

7. The method of claim 6, wherein the parameters of the class-agnostic pose estimation model f are updated by optimizing a Mean Square Error (MSE) loss function L_{H} to minimize a dissimilarity between the predicted query key-point heatmap \tilde{H}_{q} and the ground truth query key-point heatmap H_{q}:
$${ℒ}_{H} ( {\tilde{H}}_{q} , {H}_{q} ) = \frac{1}{H \times W} {\sum }_{i = 1}^{W} {\sum }_{j = 1}^{H} ( {\tilde{H}}_{q} ( i , j ) - {H}_{q} ( i , j ) ) .$$

8. The method of claim 7, wherein step (c) includes reversing the roles of the support image Iₛ and the query image I_{q}, treating the query image I_{q} with its predicted heatmaps \tilde{H}_{q} as a new support image and the support image IS with its associated ground-truth heatmaps (Hₛ) as a new query image, wherein a predicted key-point heatmaps \tilde{H}ₛ is obtained for Iₛ, which are compared to the ground truth key-point heatmaps Hₛ, wherein a reverse-role support set S={(I_{q}, \tilde{H}_{q})} and an additional forward pass is performed as follows for every (Iₛ, Hₛ)∈S:
$${\{ {\tilde{H}}_{s}^{k} \}}_{k = 1}^{K} = f ( {I}_{s} , \tilde{S} )$$
$${\tilde{H}}_{s} = {\sum }_{k = 1}^{K} {\tilde{H}}_{s}^{k} ∈ {ℛ}^{H \times W} , .$$

9. The method of claim 8 further comprising the step of refining the initial query-pose predictions P_{q} to obtain more accurate query-pose predictions Ĥ_{q}, wherein, for each testing sample represented as a tuple (I_{q}, (Iₛ, Hₛ)), where I_{q} represents the query image, Iₛ represents the support image, and Hₛ∈R^{H×W} corresponds to the ground-truth key-point heatmap for the support image, the ground-truth support image key-point heatmap Hₛ is stored in a pose pool denoted as P, wherein a k-Nearest Neighbor (kNN) algorithm is then utilized to retrieve the k-nearest neighbors support images ground truth heatmaps sharing the same view as the query image from the pose pool P as follows:
$$( {i}_{1} , {i}_{2} , … , {i}_{k} ) = kNN ( {\tilde{H}}_{q} , 𝒫 , k ) ,$$
where k is the total number of neighbors for the kNN algorithm and i₁, i₂, . . . , iₖ are the indices of the nearest neighbors of \tilde{H}_{q} in P,
wherein the predicted heatmap of the query image \tilde{H}_{q} is enhanced by averaging it with the k nearest neighbor heatmaps as follows:
$$\hat{P} = \{ {\tilde{H}}_{q} , 𝒫 ( {i}_{1} ) , 𝒫 ( {i}_{2} ) , … 𝒫 ( {i}_{k} ) \}$$
$${\hat{H}}_{q} = \frac{1}{k + 1} {\sum }_{i = 1}^{k + 1} \hat{P} ( i ) , and$$
wherein the more accurate query-pose predictions heatmap Ĥ_{q} is used instead of \tilde{H}_{q} for defining the new support set Ŝ={(I_{q}, Ĥ_{q})}, and the role-reversal step (c) is performed as follows:
$${\{ {\hat{H}}_{s}^{k} \}}_{k = 1}^{K} = f ( {I}_{s} , \hat{S} )$$
$${\hat{H}}_{s} = {\sum }_{k = 1}^{K} {\hat{H}}_{s}^{k} ∈ {ℛ}^{H \times W} .$$

10. A driver monitoring system for a vehicle, the system comprising:
an image sensor installed in the vehicle to capture images of a cabin of the vehicle including a region where the driver is located; and
an in-vehicle processor coupled to the image sensor and configured to execute a pose estimation algorithm on images captured by the image sensor using the query image and the fine-tuned pose estimation generated by the method of claim 1.

11. A system for estimating pose, comprising:
a processor configured to perform the following steps:
(a) receive a query image and a support image with original ground truth notations including key-points;
(b) perform initial pose estimation using a class-agnostic pose estimation model to predict key-points to estimate an initial pose within the query image using the support image and the original ground truth notations;
(c) using the query image with the predicted key-points designated as ground truth notations, predict key-points to estimate a pose within the support image;
(d) updating model parameters of the class-agnostic pose estimation model to optimize objective of pose estimation using the original ground truth pose of the support image along with the predicted pose of the support image obtained from step (c); and
(e) generating a fine-tuned pose estimation for the query image using: (i) the updated model parameters obtained from step (d) and (ii) the support image and its original ground truth notations.

12. The system of claim 11, wherein the step of updating model parameters includes repeating steps (c)-(d) until errors between the original pose of the support image and the predicted pose of the support image are minimized.

13. The system of claim 11, wherein step (b) includes using a heatmap representation.

14. The system of claim 13, wherein the heatmap representation H^{k} is computed using Gaussian kernels, and the equations for the heatmap is as follows:
$${H}^{k} ( x , y ) = exp ( - \frac{{( x - {x}_{k} )}^{2} + {( y - {y}_{k} )}^{2}}{2 {σ}^{2}} ) ∈ {ℛ}^{H \times W}$$
where H^{k}(x, y) is the heatmap value for key-point k at position (x, y), (xₖ, yₖ) are ground-truth key-point coordinates, σ controls the kernel's spread, and H, W are the heatmap width and height dimensions, respectively.

15. The system of claim 14, wherein a set of support images denoted as S comprises information from one or more support images, wherein S={(Iₛ, Hₛ)₁, (Iₛ, Hₛ)₂, . . . , (Iₛ, Hₛ)ₙ}, where Iₛ represents a support image and {Hₛ^{k}}ₖ^{K}=1 represents a list of key-point heatmaps, such that Hₛ^{k} represents the heatmap representation of the k'th joint key-point of the support image Iₛ and K is the maximum number of joints,
wherein the heatmap representation of all the joints of the support image IS can be obtained by:
$${H}_{s} = {\sum }_{k = 1}^{K} {H}_{s}^{k} ∈ {ℛ}^{H \times W} .$$

16. The system of claim 15, wherein the set of support images S includes only one support image Iₛ such that S={(Iₛ, Hₛ)}, and wherein a key-point heatmap \tilde{H}_{q} for the query image I_{q}, is expressed as:
$${\{ {\tilde{H}}_{q}^{k} \}}_{k = 1}^{K} = f ( {I}_{q} , S )$$
$${\tilde{H}}_{q} = {\sum }_{k = 1}^{K} {\tilde{H}}_{q}^{k} ∈ {ℛ}^{H \times W} ,$$
where f is the class-agnostic pose estimation model, and K is the number of key-points.

17. The system of claim 16, wherein the class-agnostic pose estimation model f is learned by optimizing a Mean Square Error (MSE) loss function L_{H} to minimize a dissimilarity between the predicted query key-point heatmap \tilde{H}_{q} and the ground truth query key-point heatmap H_{q}:
$${ℒ}_{H} ( {\tilde{H}}_{q} , {H}_{q} ) = \frac{1}{H \times W} {\sum }_{i = 1}^{W} {\sum }_{j = 1}^{H} ( {\tilde{H}}_{q} ( i , j ) - {H}_{q} ( i , j ) ) .$$

18. The system of claim 17, wherein step (c) includes reversing the roles of the support image Iₛ and the query image I_{q}, treating the query image I_{q} with its predicted heatmaps \tilde{H}_{q} as a new support image and the support image Iₛ with its associated ground-truth heatmaps (Hₛ) as a new query image, wherein a predicted key-point heatmaps \tilde{H}ₛ is obtained for Iₛ, which are compared to the ground truth key-point heatmaps Hₛ, wherein a reverse-role support set \tilde{S}={(I_{q}, \tilde{H}_{q})} and an additional forward pass is performed as follows for every (Iₛ, Hₛ)∈S:
$${\{ {\tilde{H}}_{s}^{k} \}}_{k = 1}^{K} = f ( {I}_{s} , \tilde{S} )$$
$${\tilde{H}}_{s} = {\sum }_{k = 1}^{K} {\tilde{H}}_{s}^{k} ∈ {ℛ}^{H \times W} , .$$

19. A driver monitoring system for a vehicle, the system comprising:
an image sensor installed in the vehicle to capture images of a cabin of the vehicle including a region where the driver is located; and
an in-vehicle processor coupled to the image sensor and configured to execute a pose estimation algorithm on images captured by the image sensor using the query image and the fine-tuned pose estimation generated by the system of claim 11.

20. A method of pose estimation performed by a processor, the processor configured to perform the following steps:
(a) receive a query image and a plurality of support images with original ground truth notations including key-points;
(b) perform initial pose estimation using a class-agnostic pose estimation model to predict key-points to estimate an initial pose within the query image using the support images and the original ground truth notations;
(c) using the query image with the predicted key-points designated as ground truth notations, predict key-points to estimate poses within the support images;
(d) updating model parameters of the class-agnostic pose estimation model to optimize objective of pose estimation using the original ground truth poses of the support images along with the predicted poses of the support images obtained from step (c); and
(e) generating a fine-tuned pose estimation for the query image using: (i) the updated model parameters obtained from step (d) and (ii) the support images and their original ground truth notations.
